(19) United States
(12) Patent Application Publication
(10) Pub. No.: US 2014/0305546 A1
(43) Pub. Date: Oct. 16, 2014

(54) CONTAINER TREATMENT MODULE TO BE USED IN CONTAINER TREATMENT MACHINES

(71) Applicant: Krones Ag, Neutraubling (DE)

(72) Inventors: Andreas Bergers, Pfatter (DE); Dieter Hafner, Regensburg (DE)

(73) Assignee: Krones Ag, Neutraubling (DE)

(21) Appl. No.: 14/169,230

(22) Filed: Jan. 31, 2014

(30) Foreign Application Priority Data
Apr. 15, 2013 (DE) 10 2013 206 685.6

(51) Int. Cl. B67C 3/24

(52) U.S. Cl. CPC B67C 3/24
USPC 141/237; 141/284

(57) ABSTRACT

A container treatment module to be used in a container treatment machine, having a frame at which a turntable and a motor allocated to the turntable and a centering facility which may center a container on the turntable are disposed, and where the container treatment module comprises at least one device for mounting the container treatment module to the container treatment machine and/or another container treatment module.

### CROSS-REFERENCE TO RELATED APPLICATION

The present application claims the benefit of priority of German Application No. 10 2013 206 685.6, filed Apr. 15, 2013. The entire text of the priority application is incorporated herein by reference in its entirety.

### FIELD OF THE DISCLOSURE

The disclosure relates to a container treatment module which may be employed in container treatment machines, for example labeling machines or filling lines.

### BACKGROUND

It is known from prior art to provide rotary machines having a rotating table with a turntable fixed on it which may either be driven centrally by a motor or separately by a servomotor, as is described, for example, in DE 10 2004 026 755 A1. In addition, such rotary machines have a superstructure at which centering devices may be provided and can center containers to be treated on the rotating table.

It is known from DE 10 2008 038 146 A1 to provide a rotating table together with the required control electronics and drives in the form of a kit which is dimensioned for different sizes of machines, in particular carousel sizes and diameters.

### SUMMARY OF THE DISCLOSURE

It is one aspect of the present disclosure to provide flexible and quickly modifiable container treatment machines which moreover permit a swift replacement of defective components.

To achieve this, the container treatment module, which is intended to be used in a container treatment machine, includes a frame at which a support plate, for example a turntable, optionally with an associated motor, and a centering facility, which may center a container on the support plate, are arranged, said container treatment module comprising at least one device for mounting it to the container treatment machine and/or another container treatment module. By providing corresponding container treatment modules, a container treatment machine may easily be equipped with an arbitrary number of treatment stations for containers, and this number may moreover be modified at any time by removing or adding further container treatment modules. Moreover, the design of the container treatment modules with devices for mounting them to the container treatment machine or to other container treatment modules permits an easy replacement of possibly defective support plates or motors or centering facilities of a certain container treatment module without having to rebuild the complete container treatment machine.

Preferably, the mounting devices may be arranged at the frame of the container treatment module.

Furthermore, the container treatment module may be designed such that it forms a complete container treatment station. This in particular includes the provision of corresponding electronics and any required components that must be contained in a container treatment station, so that only a connection of the container treatment module with any lines and electronic connections for data transmission and power transmission from the container treatment machine or a corresponding control unit is required, while the container treatment module is completely operative by itself.

Furthermore, the container treatment module may be fixed at a container treatment machine at least to one of a carousel table, a central axis, or a superstructure. Thus, an easy installation and deinstallation of the container treatment modules is permitted, for example via plug-in connections.

According to a further embodiment, a motor may be allocated to the centering facility. Thus, the operativeness of the container treatment module is completed, and the provision of external motors that would have to be adapted depending on the desired number of container treatment modules, is preferably superfluous.

Furthermore, a local control unit for controlling the centering facility and/or the support plate and/or the motors allocated to it may be provided in the container treatment module. The provision of local control units with each container treatment module ensures that a correct control of the container treatment modules is possible independent of the number of container treatment modules provided in a container treatment machine and independent of the replacement or addition of further container treatment modules.

According to an embodiment, a container treatment module may comprise at least one sensor for detecting performance parameters of the container treatment module. For example, specific performance parameters may be determined for a container treatment module, for example the position of the turntable or the force transmitted from the centering facility via a container to be treated to the turntable, or the speed of the provided motors.

According to a further embodiment, the frame includes predetermined invariable dimensions.

According to another embodiment, the container treatment module may comprise at least one variable dimension. Thus, an adaptation of the container treatment module to certain desired process parameters and its incorporation into existing process operations is possible. For example, by adjusting such a dimension, the distance to a transfer facility of containers to be filled may be varied.

The adjustment of the at least one dimension may be accomplished via components that are movable with respect to each other in this direction, where either a motor suited for moving the movable components is disposed preferably at the container treatment module, or the movable components are connected to each other via threads or other manually adjustable members which are suited for adjusting the relative position of the movable components with respect to each other.

Furthermore, the container treatment module is characterized in that it may be assembled with other, similar container treatment modules into groups of at least 10, 25, or 50 or more. By assembling such groups, one may obtain a construction that is stable enough to eliminate additional carousel tables or the like, whereby a container treatment machine comprising a plurality of container treatment modules may be employed even more flexibly.

Furthermore, the group of container treatment modules may be assembled in the form of a ring. Thus, the group of container treatment modules may take over the function of the supportive parts which would otherwise be employed in a container treatment machine, such as carousel tables, central axes or a superstructure, and replace them at least to some extent.

A container treatment machine comprising at least one, preferably at least 10, 25, or 50 or more corresponding container treatment modules may be constructed.

### BRIEF DESCRIPTION OF THE FIGURES

FIG. 1 representation of a known container treatment machine.

FIG. 2 representation of a container treatment machine according to the disclosure with container treatment modules.

FIG. 3a-e representation of various embodiments for mounting a container treatment module to a container treatment machine.

FIG. 4a representation of a frame of a container treatment module with invariable dimensions.

FIG. 4b representation of a frame of a container treatment module with variable dimensions.

FIG. 4c representation of an embodiment of a frame with moving parts.

FIG. 5 representation of an assembled group of container treatment modules.

### DETAILED DESCRIPTION OF THE PREFERRED EMBODIMENT

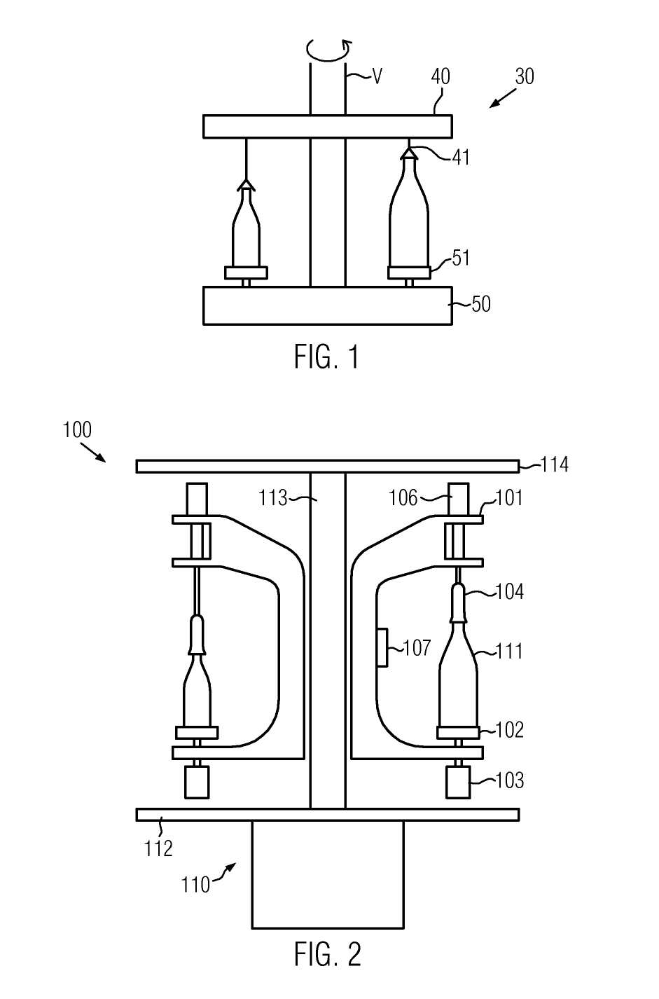

FIG. 1 shows a container treatment machine known from prior art, for example from DE 10 2004 026 755 A1, which may be suited, for example, for labeling or filling containers. The machine comprises at least one rotating table 50 on which several container treatment stations are disposed in the form of turntables 51. Individual motors may be allocated to the latter, or the control may be accomplished via a central motor. Furthermore, a corresponding container treatment machine may have a superstructure 40 in the form of a carousel at which in turn centering facilities or mountings 41 may be disposed which may take care of a stabilization of a container to be treated or else take over other jobs, for example filling. The rotating table 50 and the superstructure 40 are usually connected to each other via an axis V, so that their positions relative to one another remain constant. Normally, the turntables 51 and the centering facilities 41 are stationarily disposed at the rotating table 50 or the superstructure 40, respectively, and they may only be moved with respect to it corresponding to the required motion sequences, for example by rotating the turntables. Up to now, a replacement of individual components has only been provided in such a way that, for example, the complete rotating table with its corresponding turntables may be replaced, as is suggested in DE 10 2008 038 146 A1.

FIG. 2 shows a container treatment machine 110 which comprises container treatment modules 100 according to the disclosure. While the container treatment machine 110 may still comprise a rotating table 112 and a superstructure 114 as well as an axis 113 which take over supportive functions, the container treatment modules 100 preferably comprise all components that are essential for container treatment. For this, a frame 101 is provided for each container treatment module 100, which frame may be connected on the one hand with a part of the container treatment machine 110, for example the central axis 113, and at which frame the devices necessary for container treatment are simultaneously provided.

Depending on its field of application, meaning here a labeling machine by way of example, the frame 101 of the container treatment module 100 comprises in particular, a centering facility 104 and a support plate 102 on which the container to be treated 111 may be positioned and centered by the centering facility 104. Below, reference is mainly made to support plates 102 in the form of turntables as these are often employed in container treatment machines. However, any form of support plate is also meant to be included by that. Furthermore, a motor 103 may be fixed to the frame 101 and allocated to the turntable 102, so that the turntable 102 may be moved by the motor 103. The motor may be a motor usually employed for this purpose. For example, the use of a servomotor may be appropriate. Furthermore, another motor 106 may be provided for controlling the centering facility 104, which must be moved up and down, for example, depending on the container's size, or which must rotate when the container 111 is rotated, the motor 106 being allocated to said centering facility 104 and connected to it. Depending on the employment of the container treatment modules 100 in most diverse container treatment machines 110, other devices, for example blow molds or filling tubes for filling the container 111, may also be provided at the frame instead of the centering facility 104 and the turntable 102.

To ensure a preferably inexpensive fabrication of the frames 101, they might first be constructed to standard, independent of the container treatment machines where they will be employed, and comprise corresponding openings for installing any possible functional parts, such as turntables, motors, centering facilities, filling tubes or blow molds, and they might then be equipped with said components depending on their intended use.

Furthermore, a local control unit 107 might be allocated to each treatment module 100, said control unit being, for example, also provided at or installed in the frame 101 and suited for controlling the individual devices.

While it will still be optionally necessary to connect the container treatment modules 100 to the container treatment machine 110 via cabling and lines, by providing all components relevant for the treatment of the containers 111 at the frame 101 of the container treatment module 100, the modular design of the container treatment modules 100 permits an uncomplicated installation and deinstallation of the container treatment modules 100 into a container treatment machine 110 and at the same time a flexible composition of different numbers of container treatment modules 100 in a container treatment machine 110. A further advantage consists in that the container treatment module 100 may be adjusted already in the production process such that, after having been connected to the required lines, it is already fully operative, i.e. in particular adjusted. This helps saving a considerable amount of time for the installation of a container treatment module 100 as, for example, the turntable and the centering facility do not have to be adjusted to each other initially.

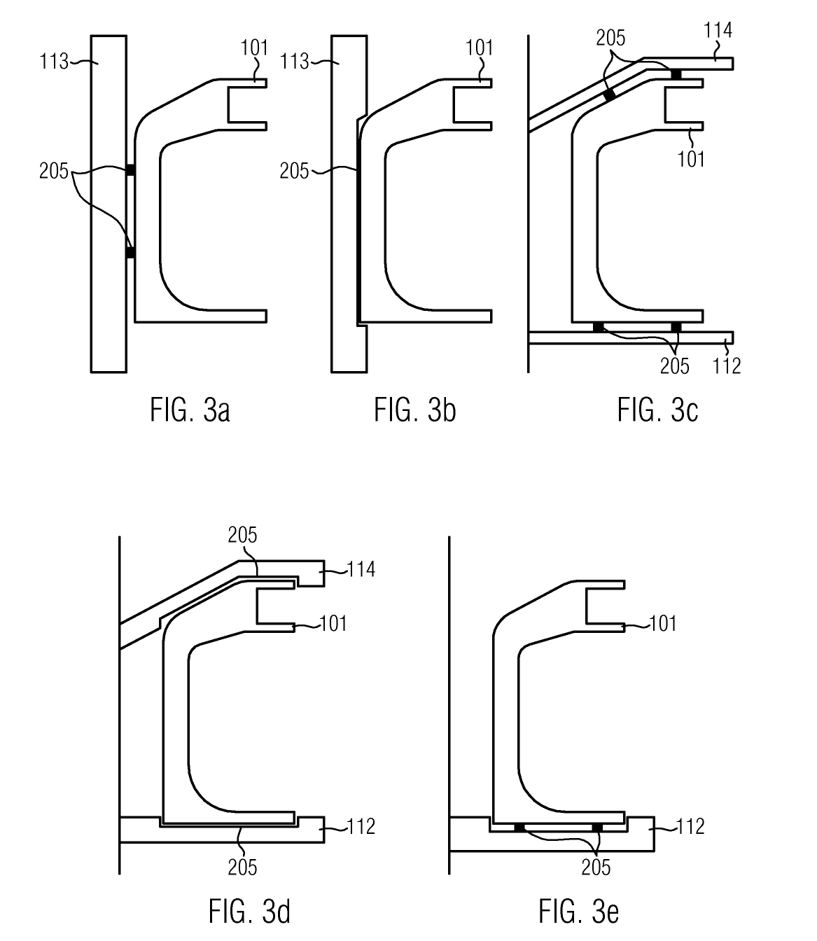

FIGS. 3a-d show possibilities of mounting a container treatment module 100 via mounting devices 205 to parts of a treatment machine, as it is represented, for example, in FIG. 2.

In FIG. 3a, a container treatment module, which is here only shown schematically via the frame 101, is fixed to the vertical axis 113 of a container treatment machine by means of connections 205. These connections may be, for example, plug-in connections, but also screwed joints, so that the frame 101 of the container treatment module may be fixed at the vertical axis 113. Since the components of the container treatment module, as described in FIG. 2, are already correctly adjusted to each other, this fixing does not require any further complex adjustment of these parts with respect to each other, which is why simple mounting devices may be used. To permit an accurately fitting mounting of the frame 101 to the central axis 113 of the container treatment machine, it may also be provided that a kind of plug-in principle is used in addition or separately for mounting the frame 101, as is shown in FIG. 3b. For this, recesses may be provided in the central axis 113 into which the frame 101 may be very exactly fitted, thus permitting an exact positioning. The fixing of the frame in such an indentation may be ensured, for example, via bolts which connect the frame with the central axis 113. Click connections may also be advantageous as long as they withstand the stresses during the operation of the container treatment machine. While an indentation in the central axis 113 of the container treatment machine is provided here, a corresponding indentation or bulging may also be provided at the frame 101 of the container treatment module.

Furthermore, according to FIGS. 3c and 3d, a corresponding mounting device 205 of the frame 101 may also be provided at the rotating table or the superstructure 112 and 114, respectively. To permit a stabilization of the position of the frame 101 with respect to the container treatment machine, it may be advantageous to provide mounting devices 205 both at the vertical axis 113 and at the rotating table 112 and the superstructure 114, if these are present. Thus, a maximum strength and stiffening of the frame 101 are ensured, whereby malpositions during the operation of the container treatment machine may be avoided.

FIG. 3d shows a further embodiment of the mounting device 205. Since the frame 101 preferably imparts the required strength and stiffness to a container treatment module, a treatment machine may also be realized without a superstructure. In this case, the frame 101 is fixed to the rotating table 112 via mounting devices, as discussed in FIGS. 3a and 3b. Thus, the superstructure may be eliminated. One can also dispense with the rotating table, and a container treatment machine comprising an axis 113 and a superstructure 114 may be constructed, where the frames 101 of the container treatment modules are fixed to the axis 113 and/or to the superstructure 114 with the above-described devices 205. Thus, one may dispense with the rotating table and create space for other devices in this region, or even fix a second row of container treatment modules to the axis 113.

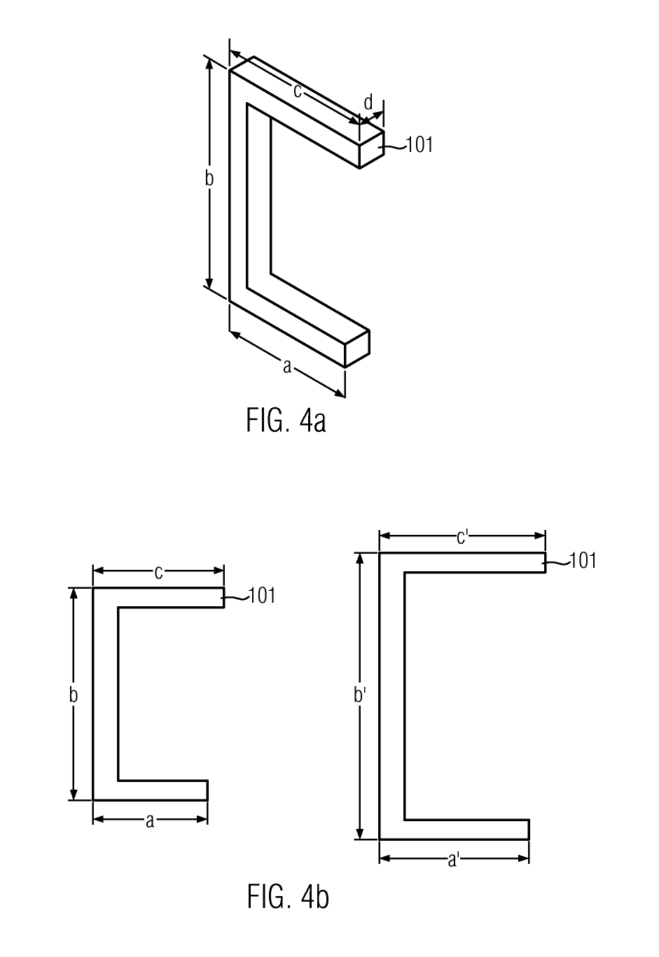

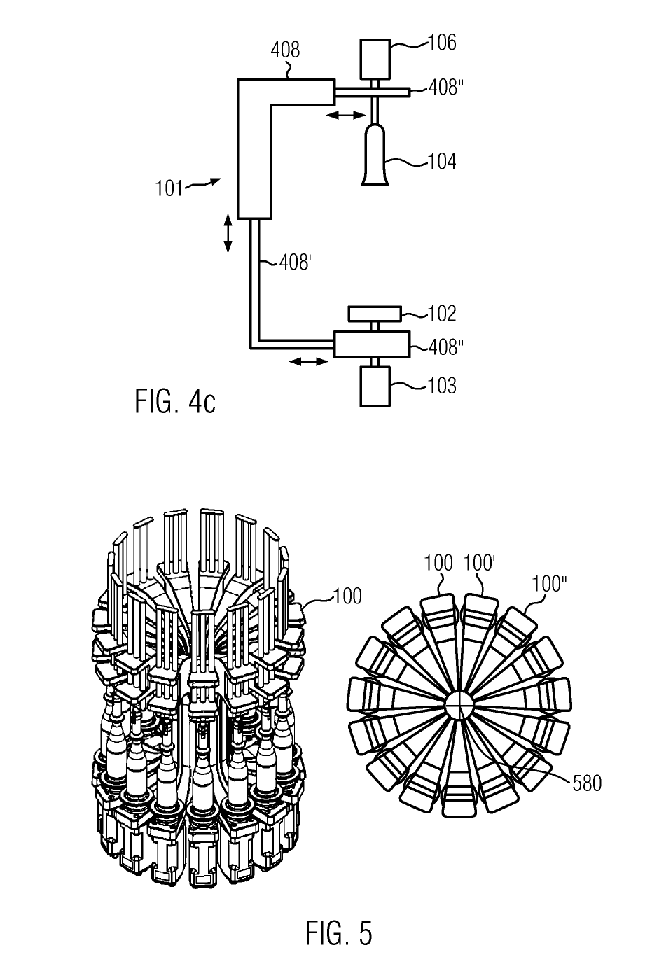

FIG. 4 shows two different embodiments of the frame 101, one in the form of predetermined, invariable dimensions (FIG. 4a) and one with variable dimensions (FIG. 4b and FIG. 4c).

According to FIG. 4a, a frame 101 with fixed dimensions a, b, c may be provided for a container treatment module. Since these dimensions are not necessarily suited for each type of container (above all containers of different sizes), a fabrication for different container types and also for different container treatment machines would be necessary, where the parameters a, b, and c specific of each type of container and container treatment machine determine the dimensions of the frame 101. The extension d perpendicular to the plane of projection in FIG. 4a may also be decisive. In particular, the extension in this direction determines how close adjacent container treatment modules may be arranged at most. This simultaneously predetermines the maximum number of possible container treatment modules when a diameter, for example of a carousel to be inserted into a container treatment machine, is given.

The fabrication of a frame 101 with invariable predetermined dimensions a, b, c and optionally d, however, offers very good properties in view of the stability of the frame, as the frame may be molded, for example, by injection molding. Thus, the frame may advantageously consist of a hollow metal or light metal or a plastic bend having, for example, the shown shape and in which cablings and lines may be guided through corresponding openings. The frame may then be surrounded by plastics or the like by means of an injection-molding process to obtain a light and simultaneously stable construction.

However, it may also be advantageous for the dimensions a, b, c, as shown in FIG. 4b, to be variable, so that they may be enlarged or reduced, for example to obtain the dimensions a′, b′, c′, depending on certain requirements. If, for example, one and the same frame 101 is used in one container treatment module, an adaptation to differently sized containers may be accomplished without having to replace the frame. Thereby, an adjustment to different container sizes without replacing the container treatment modules is possible in one and the same container treatment machine.

A realization of the variable dimensions a, b, and c (a variation of the dimension d is not indicated here, but may be appropriate under certain circumstances) is illustrated in FIG. 4c.

To ensure the variability of the dimensions, the frame 101 is assembled, for example, from four components 408 to 408″ which are movable with respect to each other. A smaller or higher number of movable components may also be provided. These are connected to each other (for example inserted into one another, or connected to each other via extendable connections). Advantageously, the devices relevant for the treatment of a container, for example a turntable 102 and a centering device 104, and the allocated motors 103 and 106 are each located at one of the movable components 408″ and 408′″.

The connection of the movable components 408 to 408′″ with respect to each other is provided such that even at a maximum extension, a′, b′, c′, as shown, for example, in FIG. 4b, the complete frame 101 is at least stiff and strong enough to fulfill the requirements during the container treatment. For this, it is suitable for the movable components 408 to 408′″ to overlap each other each in pairs. This means that, for example, the component 408′ in each case penetrates the movable component 408 to a certain minimum value. Minimum penetration depths of 2 to 20 cm, for example, are suited for this. Additionally, at least those regions of the moving parts 408 and 408′ which definitively enclose each other may be magnetic, so that an additional protection against undesired movements and vibrations is achieved.

To adjust the dimensions a, b and c or a′, b′ and c′, either motors may be provided which may be connected with the local control unit, for example described in FIG. 2, and which may move the parts 408 to 408′″ with respect to each other, or else the dimensions of the movable components 408 to 480′″ may be adjusted manually. For this, it may be provided, for example, that the movable components 408 to 480′″ are connected to each other in the form of telescopic arms or telescopic pipes and include arrests at certain intervals (for example for different standardized container sizes). These arrests may be embodied, for example, in the form of catches. Since the frames 101 may be highly stressed due to forces occurring during the container treatment, the catches or general arrests must be designed such that they are not damaged themselves even under high stress and simultaneously take care of a high stability of the complete frame 101. For this, magnetic connections may also offer themselves here, and furthermore, not only one arrest but several arrests distributed at the periphery of the movable components 408 to 408′″ may be provided. For example, with a set adjustment of the dimensions a, b, and c, four arrests each may be provided for these dimensions, i.e. four arrests for dimension a, for dimension b and for dimension c, so that on the one hand, high stability and on the other hand also a protection against a possible malfunction of one of the arrests are ensured.

FIG. 5 shows a group of container treatment modules 100 to 100″ which are connected in the form of a circle and in this manner may form a rotary machine. The connections of a container treatment module described in FIG. 3 with components of the carousel may here be transferred to connections of the individual container treatment modules among each other. For example, the container treatment module 100′ may be connected with the container treatment modules 100 and 100″ by suited mounting devices. Preferably, these connections may be adjusted to most diverse angles, so that an arbitrary number (for example 5, 10, 25, 50 or more) of container treatment modules may be combined. To connect the individual container treatment modules with required lines and cablings, a central line may be provided in the center of the circle shown in FIG. 5. This may be realized, for example, in the form of a hollow metal tube through which the corresponding lines are guided and which includes junctions to the individual container treatment modules.

It should be noted that the arrangement of the container treatment modules 100 to 100″ in the form of a rotary machine is not compulsory. The container treatment modules may also be combined in the form of a chain, in particular in the form of a straight line.

What is claimed is:

1. A container treatment module for use in a container treatment machine, comprising a frame, at which a support plate and a centering facility which centers a container on the support plate are arranged, and at least one device for mounting the container treatment module to at least one of the container treatment machine and/or another container treatment module.

2. The container treatment module according to claim 1, wherein the mounting device is arranged at the frame.

3. The container treatment module according to claim 1, wherein the container treatment module forms a complete container treatment station.

4. The container treatment module according to claim 1, wherein the container treatment module is fixed to at least one of
a carousel table;
a central axis; and
a superstructure
of the container treatment machine.

5. The container treatment module according to claim 1, wherein the container treatment module furthermore comprises a motor allocated to the centering facility.

6. The container treatment module according to claim 1, wherein the container treatment module furthermore comprises a local control unit for controlling the centering facility and/or the support plate and/or motors allocated to them.

7. The container treatment module according to claim 1, wherein the container treatment module furthermore comprises at least one sensor for detecting performance parameters of the container treatment module.

8. The container treatment module according to claim 1, wherein the frame comprises predetermined invariable dimensions (a, b, c).

9. The container treatment module according to claim 1, wherein the frame comprises at least one variable dimension (a, a′, b, b′, c, c′).

10. The container treatment module according to claim 9, wherein an adjustment of the at least one dimension is accomplished via components movable with respect to each other in this direction, where either
a motor suited for moving the movable components is disposed at the container treatment module, or
the movable components are connected to each other via threads or other manually adjustable members which are suited to adjust the relative position of the movable components with respect to each other.

11. The container treatment module according to claim 1, wherein the container treatment module is assembled with other, similar container treatment modules into a group of at least 10 container treatment modules.

12. A group of container treatment modules according to claim 1, wherein the group of container treatment modules are assembled in the form of a ring.

13. The container treatment machine according to claim 1, wherein the container treatment machine comprises at least 10, 25, or 50 or more container treatment modules.

14. The container treatment module according to claim 1, wherein the support plate comprises a turntable with an associated motor.
